(19) United States
(12) Patent Application Publication
(10) Pub. No.: US 2007/0104078 A1
(43) Pub. Date: May 10, 2007

(54) Apparatus and method for reading information from an information carrier

(75) Inventors: Bin Yin, Eindhoven (NL); Albert Hendrik Jan Immink, Eindhoven (NL); Alexander Padiy, Eindhoven (NL); Willem Marie Julia Marcel Coene, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/579,411

(22) PCT Filed: Nov. 3, 2004
(86) PCT No.: PCT/IB04/52285

§ 371 Date: May 15, 2006

(51) Int. Cl. G11B 7/00

(52) U.S. Cl. 369/124.03

(57) ABSTRACT

In modem optical disc systems, inter-track spacing is chosen relatively small in order to allow high storage densities. As a result, the optical spot has a radius comparable with the track pitch, and the data written on neighboring tracks appear in the target track signal in the form of inter-track interference (cross-talk). To tackle the cross-talk problem, cross-talk canceling schemes are normally employed. These schemes use three spots, one spot on the main track and two satellite spots on adjacent tracks. The read signal (C) is improved by minimizing the cross-talk between the satellite signals (S⁺,S⁻) and the read signal (C). However, due to the decreasing inter-track spacing, the decorrelation concept fails since the satellite spots read too much central track information and become strongly correlated with the read signal (C), which causes “leakage” in the decorrelation. The present invention solves this problem with an additional circuit for outputting improved satellite signals (\check{S}⁺, \check{S}⁻)which circuit suppresses cross-talk of the main track present in the satellite signals (S⁺,S⁻) by minimizing a correlation between the satellite signals (S⁺,S⁻) and the read signal (C), the improved satellite signals (\check{S}⁺, \check{S}⁻)being subsequently fed to the first circuit which is arranged to suppress the cross-talk of the read signal (C) by minimizing a correlation between the improved read signal (\check{C}) and the improved satellite signals (\check{S}⁺, \check{S}⁻).

The present invention relates to an apparatus for reading information from an information carrier having tracks, comprising

a radiation source for generating a main beam and two satellite beams,

objective means for directing the main beam to a main track and the two satellite beams to locations adjacent to the main track,

detection means for converting a reflection of the main beam from the information carrier to a read signal which contains information of the main track, and for converting reflected satellite beams to satellite signals containing information of tracks adjacent to the main track,

cross-talk removing means for outputting an improved read signal, comprising a first circuit for suppressing cross-talk of the adjacent tracks present in the read signal. The present invention also relates to a method for reading information from an information carrier having tracks, comprising the steps of

generating a main beam and two satellite beams,

directing the main beam to a main track and the two satellite beams to locations adjacent to the main track,

converting a reflection of the main beam from the information carrier to a read signal which contains information of the main track, and converting reflected satellite beams to satellite signals containing information of tracks adjacent to the main track,

outputting an improved read signal which is derived from the read signal by suppressing cross-talk of the adjacent tracks present in the read signal.

In modem optical disc systems, inter-track spacing is chosen relatively small in order to allow high storage densities. As a result, the optical spot, formed by the main beam on the track, has a radius comparable with the track pitch. The data written in the neighboring tracks appear in the target track signal in the form of inter-track interference, or so called cross-talk. The situation becomes even more severe with an abberated optical spot, e.g. due to radial tilt or defocus. In case of an abberated optical spot the optical spot extends more onto the neighboring tracks. Also the interference increases when the data density is pushed even further in the next-generation storage formats.

To tackle the inter-track interference problem, cross-talk canceling techniques are normally employed. For 3-spot cross-talk canceling, two architectures have been typically chosen. In the first architecture, two satellite spots are placed on the immediate sidetracks, while in the second architecture the satellite spots are located half way between the main track and the sidetracks. A filtering and adding method takes place in both architectures according to the equation:

$${( {f}_{k}^{\pm } )}_{m + 1} = ( 1 - μ ) {( {f}_{k}^{\pm } )}_{m} + μ ( - \frac{\partial J}{\partial {f}_{k}^{\pm }} {\vert}_{{f}_{k}^{\pm } = {( {f}_{k}^{\pm } )}_{m}} )$$

wherein ƒₖ⁺ and ƒₖ⁻ denote FIR filters applied to the two satellite signals, respectively, Cₘ denotes the read signal, \tilde{C}ₘ the improved read signal, and Sₘ⁺ and Sₘ⁻; denote the satellite signals. An LMS algorithm updates the coefficients of the filters, which is driven by minimizing a cost function J(ƒₖ⁺,ƒₖ⁻):

$${\tilde{C}}_{m} = {C}_{m} - {\sum }_{k} {f}_{k}^{+} {S}_{m - k}^{+} - {\sum }_{k} {f}_{k}^{-} {S}_{m - k}^{-}$$

J(ƒₖ⁺,ƒₖ⁻) can be defined as the cross-correlation between the improved read signal \tilde{C}ₘ and the two satellite signals:
J(ƒₖ⁺,ƒₖ⁻)≈Jₘ(ƒₖ⁺,ƒₖ⁻)=(\tilde{C}ₘSₘ⁺)² +(\tilde{C}ₘSₘ⁻)²

where the cross-correlations have been approximated by their instant values.

When the track pitch is decreasing the above described decorrelation concept fails since the satellite spots read too much main track information and become strongly correlated with the read signal, which causes “leakage” in decorrelation. Especially in the case of the second architecture where the satellite spots are placed halfway between the main track and the sidetracks. In this second architecture the spots are located closer to the main track and this results in a strong correlation between the read signal and the satellite signals.

It is therefore a first object of the invention to provide an apparatus for reading information from an information carrier which is able to read information even in the presence of severe cross-talk in the satellite signals.

It is a second object of the invention to provide a method for reading information from an information carrier which is able to read information even in the presence of severe cross-talk in the satellite signals.

According to the invention the first object is achieved with an apparatus as described in the opening paragraph wherein the cross-talk removing means further comprise a second circuit for outputting improved satellite signals by suppressing cross-talk of the main track present in the satellite signals by minimizing a correlation between the satellite signals and the read signal, the improved satellite signals being subsequently fed to the first circuit which is arranged to suppress the cross-talk of the read signal by minimizing a correlation between the improved read signal and the improved satellite signals.

So, even if the satellite signals contain severe cross-talk of the main track, still the apparatus according to the invention is capable of using the satellite signals to remove cross-talk of the sidetracks present in the read signal. The apparatus according to the invention first cleans the satellite signals from cross-talk of the main track. The second circuit suppresses the cross-talk of the main track present in the satellite signals by minimizing a correlation between the satellite signals and the read signal. This can for instance be done by an adjustable filter which is adjusted by using a Least Mean Square (LMS) algorithm. The LMS algorithm can be driven by minimizing a cost function which is defined by the cross-correlation between the improved satellite signals and the read signal. Subsequently, with the cleaned or improved satellite signals the cross-talk of the sidetrack present in the read signal is removed in a similar manner. For that purpose, the first circuit is arranged to suppress the cross-talk in the read signal by minimizing the correlation between the improved read signal and the improved satellite signals. This minimization can also be performed by using a LMS algorithm which adjusts one or more coefficients of a filter. Again, the LMS algorithm can be driven by minimizing a cost function which is defined by the cross-correlation between the improved satellite signals and the improved read signal.

In an embodiment of the invention the satellite beams are directed to a position halfway between the main track and the adjacent tracks. This embodiment is advantageous with regard to the aspect that the satellite spots used for 3-spot push-pull radial tracking can be reused. The 3-spot push-pull radial tracking is used in all rewritable optical disc systems.

In an other embodiment of the invention the satellite beams are directed towards the adjacent tracks. This embodiment is advantageous with regard to the aspect that the satellite signals contain less cross-talk of the main track in comparison to the situation of the previous embodiment.

In a further embodiment the first circuit comprises

a first variable filter for filtering a first improved satellite signal, the filter having at least one adjustable coefficient,

a second variable filter for filtering a second improved satellite signal, the filter having at least one adjustable coefficient,

a first subtractor for subtracting the filtered improved satellite signals from the read signal and outputting the improved read signal,

a first coefficient control device for minimizing a correlation between the first improved satellite signal and the improved read signal by controlling the adjustable coefficient of the first variable filter,

a second coefficient control device for minimizing a correlation between the second improved satellite signal and the improved read signal by controlling the adjustable coefficient of the second variable filter.

In a further embodiment the second circuit comprises

a third variable filter for filtering the read signal and outputting a first filtered read signal, the filter having at least one adjustable coefficient,

a second subtractor for subtracting the first filtered read signal from the first satellite signal and outputting the first improved satellite signal,

a third coefficient control device for minimizing a correlation between the first improved satellite signal and the read signal by controlling the adjustable coefficient of the third variable filter,

a fourth variable filter for filtering the read signal and outputting a second filtered read signal, the filter having at least one adjustable coefficient,

a third subtractor for subtracting the second filtered read signal from the second satellite signal and outputting the second improved satellite signal, and

a fourth coefficient control device for minimizing a correlation between the second improved satellite signal and the read signal by controlling the adjustable coefficient of the fourth variable filter.

The variable filters can for instance be Finite Impulse Response (FIR) filters. These filters contain tap delays and gain elements. FIR filters are well known to the person skilled in the art. The gain of one or more gain elements can be adjustable and determine the characteristics of the FIR filter. The at least one adjustable coefficient in case of a FIR filter is thus the gain of the one or more gain elements.

In a further embodiment the first coefficient control device is arranged to minimize the correlation between the improved read signal and the first improved satellite signals by minimizing the cost function:
J(ƒₖ⁺)=(\tilde{C}\tilde{S}⁺)²

wherein J is the cost function, ƒₖ⁺ is the at least one adjustable coefficient of the first variable filter, \tilde{C} is the improved read signal, \tilde{S}⁺ is the first improved satellite signal

and wherein the second coefficient control device is arranged to minimize the correlation between the improved read signal and the second improved satellite signals by minimizing the cost function:
J(ƒₖ⁻)=(\tilde{C}\tilde{S}⁺)²

wherein ƒₖ⁻ is the at least one adjustable coefficient of the second variable filter, and \tilde{S}⁻ is the second improved satellite signal.

In a still further embodiment the third coefficient control device is arranged to minimize the correlation between the first satellite signal and the read signal by minimizing the cost function:
J_{S}(gₖ⁺)=(C\tilde{S}⁺)²

wherein J_{S} is the cost function, gₖ⁺ is the at least one adjustable coefficient of the third variable filter, C is the read signal, \tilde{S}⁺ is the first improved satellite signal and the fourth coefficient control device is arranged to minimize the correlation between the second satellite signal and the read signal by minimizing the cost function:
J_{S}(gₖ⁻)=(C\tilde{S}⁻)²

wherein gₖ⁻ is the at least one adjustable coefficient of the fourth variable filter and \tilde{S}⁻ is the second improved satellite signal. These cost functions have proved to be very effective in minimizing the correlation between the read signal and the satellite signals.

In an advantageous embodiment the improved read signal is fed back to the second circuit and the first circuit is arranged to suppress cross-talk of the main track present in the satellite signals by minimizing a correlation between the improved satellite signals and the improved read signal. The first circuit and the second circuit in this embodiment work in closed loop. In operation, the feedback loop can be open at the starting-up period until the central spot signal gets “cleaned”. This embodiment still can function correctly, even in the presence for instance large radial tilt. Because of the feedback loop the circuit tend to function in an “upward spiral”, i.e. the read signal is improved by the improved satellite signal, after which the satellite signal will get even more improved because of the improved read signal, after which the read signal can be improved even further, and so on.

According to the invention the second object is achieved with a method as described in the opening paragraph method which further comprises the step of outputting improved satellite signals by suppressing cross-talk of the main track present in the satellite signals by minimizing a correlation between the satellite signals and the read signal, and wherein the step of outputting an improved read signal suppresses cross-talk of the adjacent tracks present in the read signal by minimizing a correlation between the improved read signal and the improved satellite signals.

Due to employing the decorrelation concept, the invention is not limited to traditional Run Length Limited (RLL) based storage systems, and can also be used in Multi Level storage systems and very-high density regimes of RLL-based storage systems. For the same reason the principle of the invention works before timing recovery so that the ramp-up problem and the need of data-aiding are absent.

These and other aspects of the invention will be apparent from and elucidated further with reference to the embodiments described by way of example in the following description and with reference to the accompanying drawings, in which

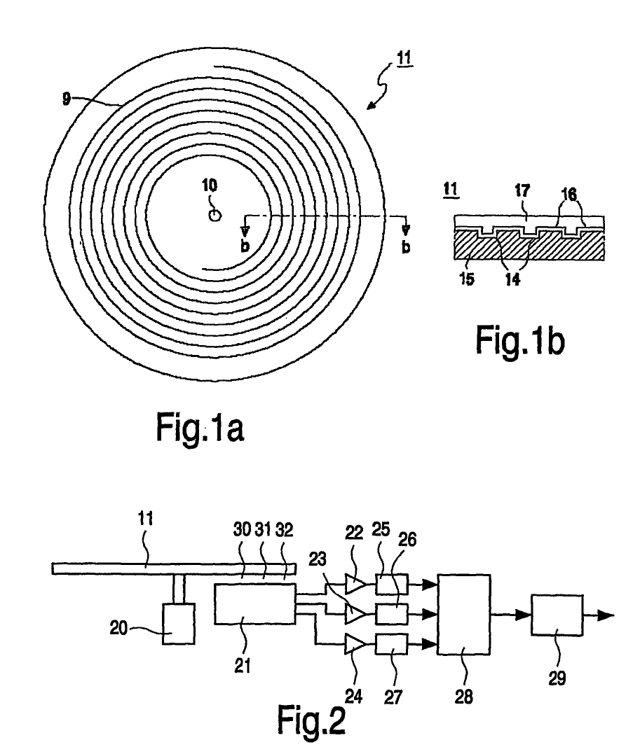

FIG. 1a shows an information carrier (top view),

FIG. 1b shows an information carrier (cross section),

FIG. 2 shows an apparatus for reading information according to the invention,

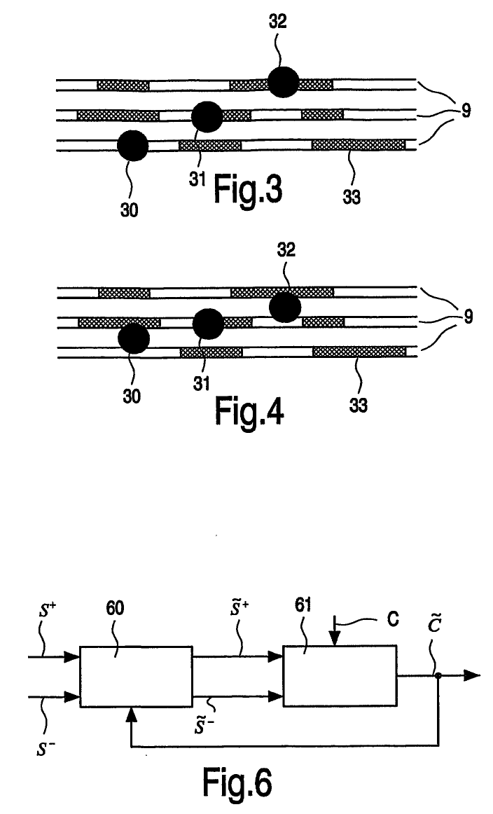

FIG. 3 shows three spots on adjacent tracks,

FIG. 4 shows a spot on a main track and two spots in between the main track and adjacent tracks,

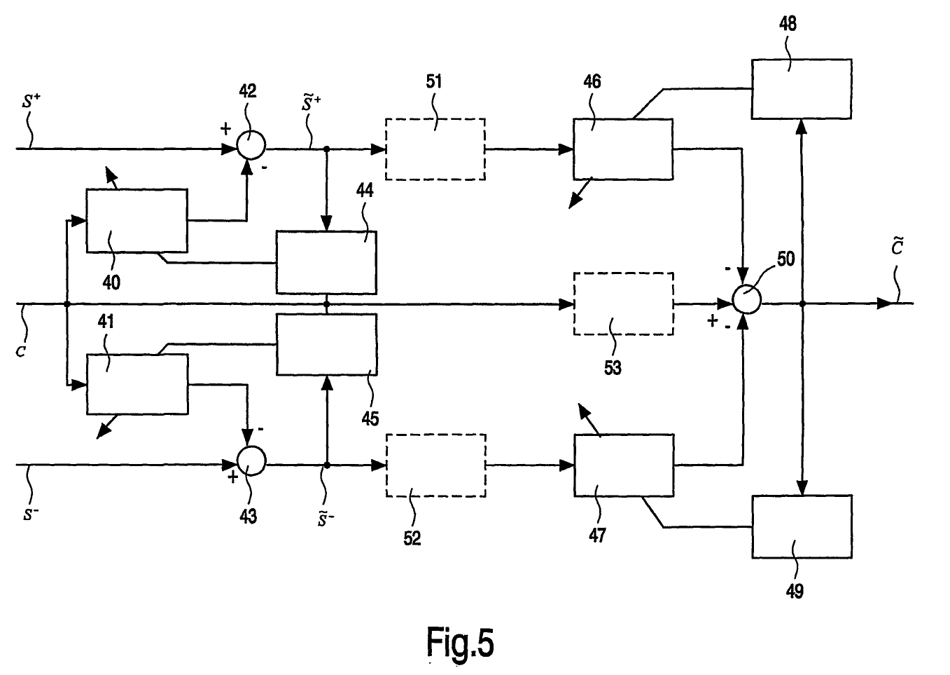

FIG. 5 shows cross-talk removing means according to the invention, and

FIG. 6 shows an other embodiment of the invention.

FIG. 1a shows a disc-shaped information carrier 11 having a track 9 and a central hole 10. The track 9, being the position of the series of (to be) recorded marks representing information, is arranged in accordance with a spiral pattern of turns constituting substantially parallel tracks on an information layer. The information carrier may be optically readable, called an optical disc, for instance a CD-ROM. The information carrier can also have an information layer of a recordable type. Examples of a recordable disc are the CD-R and CD-RW, writable versions of DVD, such as DVD+RW, and Blu-ray Disc. Further details about the DVD disc can be found in reference: ECMA-267: 120 mm DVD—Read-Only Disc-(1997). The information is represented on the information layer by recording optically detectable marks along the track, e.g. crystalline or amorphous marks in phase change material. The track 9 on the recordable type of information carrier is indicated by a pre-embossed track structure provided during manufacture of the blank information carrier. The track structure is constituted, for example, by a pregroove 14 which enables a read/write head to follow the track during scanning. The track structure comprises position information, e.g. addresses, for indication the location of units of information, usually called information blocks. The position information includes specific synchronizing marks for locating the start of such information blocks. The position information is encoded in frames of modulated wobbles as described below.

FIG. 1b shows a part of a cross-section taken along the line b-b of the information carrier 11 of the recordable type, in which a transparent substrate 15 is provided with a recording layer 16 and a protective layer 17. The protective layer 17 may comprise a further substrate layer, for example as in DVD where the recording layer is at a 0.6 mm substrate and a further substrate of 0.6 mm is bonded to the back side thereof. The pregroove 14 may be implemented as an indentation or an elevation of the substrate 15 material, or as a material property deviating from its surroundings.

The information carrier 11 is intended for carrying information represented by modulated signals comprising frames. A frame is a predefined amount of data preceded by a synchronizing signal. Usually such frames also comprise error correction codes, e.g. parity words. A number of such frames constitute an information block, the information block comprising further error correction words. The information block is the smallest recordable unit from which information can be reliably retrieved. An example of such a recording system is known from the DVD system, in which the frames carry 172 data words and 10 parity words, and 208 frames constitute an ECC block.

The apparatus for reading information as shown in FIG. 2 comprises rotating means 20 for rotating the information carrier 11. The optical pickup unit 21 comprises a radiation source for generating a main beam 31 and two satellite beams 30 and 32. The optical pickup unit 21 further comprises objective means for directing the main beam 31 to a main track and the two satellite beams to adjacent tracks. The beams are focused to spots on the tracks. The beams are reflected by the information carrier and the optical pickup unit 21 comprises detection means for converting the reflected main beam to a read signal which contains information of the main track, and for converting reflected satellite beams to satellite signals containing information of tracks adjacent to the main track.

The read signal and satellite signals are fed to amplifing units 22, 23 and 24. The resulting signals are digitized by analog to digital converters (A/D converters) 25, 26 and 27. Subsequently the digitized signals are fed to the cross-talk removing means 28. The cross talk removing means remove cross-talk from the read signal by using the satellite signals. The improved read signal is then fed to decoding means 29 which decodes the read signal.

To tackle the inter-track interference problem, cross-talk canceling techniques (XTC) are normally employed. For 3-spot XTC, two architectures have been typically chosen, as shown in FIG. 3 and FIG. 4. In the first architecture (FIG. 3), two satellite spots are placed on the immediate sidetracks, while in the second architecture (FIG. 4), the satellite spots are placed half way between the central track and each of the sidetracks.

A filtering and adding method takes place in both architectures, according to:

$${\tilde{C}}_{m} = {C}_{m} - {\sum }_{k} {f}_{k}^{+} {S}_{m - k}^{+} - {\sum }_{k} {f}_{k}^{-} {S}_{m - k}^{-}$$

Wherein Cₘ denotes the read signal, \tilde{C}ₘ denotes the improved read signal, Sₘ⁺ the first satellite signal, Sₘ⁻ the second satellite signal, and ƒₖ⁺ and ƒₖ⁻ denote FIR filters applied to the satellite spot signals, respectively. An LMS algorithm updated the coefficients of the filters, which is driven by minimizing a cost function J(ƒₖ⁺,ƒₖ⁻),

$${( {f}_{k}^{\pm } )}_{m + 1} = ( 1 - μ ) {( {f}_{k}^{\pm } )}_{m} + μ ( - \frac{\partial J}{\partial {f}_{k}^{\pm }} {\vert}_{{f}_{k}^{\pm } = {( {f}_{k}^{\pm } )}_{m}} ) \qquad ( 1 )$$

J(ƒₖ⁺, ƒₖ⁻) can be defined as the cross-correlation between the improved read signal \tilde{C}ₘ and the two satellite signals:
J(ƒₖ⁺,ƒₖ⁻)≈Jₘ(ƒₖ⁺,ƒₖ⁻)=(\tilde{C}ₘSₘ⁺)²+(\tilde{C}ₘSₘ⁻)²

where the cross-correlations have been approximated by their instant values.

The second architecture is looked at because the satellite spots used for 3-spot push-pull radial tracking (which is used in all rewritable optical disc systems) can be reused and therefore it is advantageous to use. However, in this case the decorrelation concept of the known art fails since the satellite spots read too much main track information and become strongly correlated with the read signal, which causes “leakage” in decorrelation. Also, with decreasing track pitch, in the first architecture satellite signals become more correlated with the read signal. To deal with this problem, the cost function J(ƒₖ⁺,ƒₖ⁻) has been designed differently based on so-called jitter value. The jitter reflects the deviation of the actual sampling moments from the ideal (for the bit detection) sampling moments. Two types of jitters have been used, the data-to-clock jitter and the data-to-data jitter. The advantage of the latter is that the XTC runs completely in asynchronous domain so that the timing recovery benefits from it and the ramp-up problem is avoided.

However, the application of jitter-based XTC schemes is limited to the case where run-length-limited (RLL) channel coding is employed, i.e. it is assumed that the size of the marks written on the disc is an integer multiple of the reference unit mark size. This is of course not always satisfied, e.g. in the multi-level recording. Additionally, in high density RLL-based storage systems, those schemes are not applicable since the zero-crossing of the signal waveform, the basis for the jitter measurement, could have very large phase error due to severe ISI, and even disappear when the corresponding frequencies lie beyond the cut-off of the channel. The present invention is not limited to RLL channel of a traditionally density and works before timing recovery so that the ramp-up problem and the need of data-aiding are absent.

The new scheme according to the invention has two stages. In the first stage the signals read by the satellite spot, i.e. the satellite signals S⁺ and S⁻ are pre-processed as shown in FIG. 5. The improved satellite signals have the form of
\tilde{S}ₘ^{±}=S^{±}ₘ−gₖ^{±}*Cₘ

where gₖ⁺ and gₖ⁻ denote FIR filters applied to the read signal for two decorrelation branches, respectively, and * expresses the convolution. As shown in FIG. 5 the third variable filter 40 filters the read signal and subsequently this filtered read signal is subtracted from the first satellite signal S⁺ by the second subtractor 42. The fourth variable filter 41 also filters the read signal and subsequently this filtered read signal is subtracted from the second satellite signals by the third subtractor 43. The coefficients of the variable filters are updated by an LMS algorithm, where the cost function becomes J(gₖ^{±}) and is defined as the cross-correlation between the improved satellite signals and the read signal. For the first satellite signal this is performed by the first coefficient control device 44 which minimizes the cost function
J(gₖ⁺)≈Jₘ(gₖ⁺)=(Cₘ\tilde{S}ₘ₋₊)²

by updating the coefficients gₖ⁺ of the third variable filter 40.

For the second satellite signal this is performed by the second coefficient control device 45 which minimizes the cost function
J(gₖ⁻)≈Jₘ(gₖ⁻)=(Cₘ\tilde{S}ₘ⁻)²

by updating the coefficients gₖ⁻ of the fourth variable filter 41.

The XTC actually happens in the second stage. The second stage generates an improved read signal according to
\tilde{C}ₘ=Cₘ−ƒₖ⁺*\tilde{S}ₘ⁺−ƒₖ⁻*\tilde{S}ₘ⁻

The coefficients are updated again in the same form as (1) except that the cost function J(ƒₖ⁺) changes to
J(ƒₖ⁺,ƒₖ⁻)≈Jₘ(ƒₖ⁺,ƒₖ⁻)=(Cₘ\tilde{S}ₘ⁺)²+(Cₘ\tilde{S}ₘ⁻)²

that is the cross-correlation between the improved read signal and the improved satellite signals.

Optionally a fixed equalizer 53 can be inserted for the read signal. Also optionally two channel filters 51 and 52 can be implemented for the satellite signal. The two channel filters are pre-calculated based on the prior knowledge of the channel characteristics in order to ease the following adaptation parts in both complexity and converging speed.

In the first stage also a part of the adjacent track signals may be removed because the read signal contains some none zero cross-talk of the adjacent tracks. As a solution the read signal used in the first stage can be replaced by the read signal after XTC. This is schematically shown in FIG. 6. In this embodiment, the two stages work sequentially. First the satellite signals are fed to the first stage 60. The first stage 60 improves the satellite signals by minimizing the correlation between the improved satellite signals and the improved read signal \tilde{C}. The second stage 61 outputs the improved read signal \tilde{C} by minimizing the correlation between the improved satellite signals and the improved read signal. The improved read signal \tilde{C} is fed back to the first stage 60. At start-up the feedback loop may be open until the read signal is improved. This embodiment may still work in the presence of for instance large radial tilt.

1. An apparatus for reading information from an information carrier (11) having tracks (9), comprising
a radiation source for generating a main beam (31) and two satellite beams (30,32),
objective means for directing the main beam (31) to a main track and the two satellite beams (30,32) to locations adjacent to the main track,
detection means for converting a reflection of the main beam (31) from the information carrier (11) to a read signal (C) which contains information of the main track, and for converting reflected satellite beams to satellite signals (S⁺,S⁻) containing information of tracks adjacent to the main track,
cross-talk removing means (28) for outputting an improved read signal (\tilde{C}), comprising a first circuit for suppressing cross-talk of the adjacent tracks present in the read signal (C),
characterized in that the cross-talk removing means (28) further comprise a second circuit for outputting improved satellite signals (\tilde{S}⁺,\tilde{S}⁻) by suppressing cross-talk of the main track present in the satellite signals (S⁺,S⁻) by minimizing a correlation between the satellite signals (S⁺,S⁻) and the read signal (C), the improved satellite signals (\tilde{S}⁺,\tilde{S}⁻) being subsequently fed to the first circuit which is arranged to suppress the cross-talk of the read signal (C) by minimizing a correlation between the improved read signal (\tilde{C}) and the improved satellite signals (\tilde{S}⁺,\tilde{S}⁻).

2. An apparatus as claimed in claim 1, wherein the satellite beams (30,32) are directed to a position halfway between the main track and the adjacent tracks.

3. An apparatus as claimed in claim 1, wherein the satellite beams (30,32) are directed towards the adjacent tracks.

4. An apparatus as claimed in claim 1, wherein the first circuit comprises
a first variable filter (46) for filtering a first improved satellite signal (\tilde{S}⁺), the filter having at least one adjustable coefficient,
a second variable filter (47) for filtering a second improved satellite signal (\tilde{S}⁻), the filter having at least one adjustable coefficient,
a first subtractor (50) for subtracting the filtered improved satellite signals (\tilde{S}⁺,\tilde{S}⁻) from the read signal (C) and outputting the improved read signal (\tilde{C}),
a first coefficient control device (48) for minimizing a correlation between the first improved satellite signal (\tilde{S}⁺) and the improved read signal (\tilde{C}) by controlling the adjustable coefficient of the first variable filter (46),
a second coefficient control device (49) for minimizing a correlation between the second improved satellite signal (\tilde{S}⁺) and the improved read signal (\tilde{C}) by controlling the adjustable coefficient of the second variable filter (47).

5. An apparatus as claimed in claim 1, wherein the second circuit comprises a third variable filter (40) for filtering the read signal (C) and outputting a first filtered read signal, the filter having at least one adjustable coefficient,
a second subtractor (42) for subtracting the first filtered read signal from the first satellite signal (S⁺) and outputting the first improved satellite signal (\tilde{S}+),
a third coefficient control device (44) for minimizing a correlation between the first improved satellite signal (\tilde{S}⁺) and the read signal (C) by controlling the adjustable coefficient of the third variable filter (40),
a fourth variable filter (41) for filtering the read signal (C) and outputting a second filtered read signal, the filter having at least one adjustable coefficient,
a third subtractor (43) for subtracting the second filtered read signal from the second satellite signal and outputting the second improved satellite signal (\tilde{S}⁻), and
a fourth coefficient control device (45) for minimizing a correlation between the second improved satellite signal (\tilde{S}⁻) and the read signal by controlling the adjustable coefficient of the fourth variable filter (41).

6. An apparatus as claimed in claim 4, wherein the first coefficient control device (48) is arranged to minimize the correlation between the improved read signal (\tilde{C}) and the first improved satellite signal (\tilde{S}⁺) by minimizing the cost function:
J(ƒₖ⁺)=(\tilde{C}\tilde{S}⁺)²
wherein J is the cost function, ƒₖ⁺ is the at least one adjustable coefficient of the first variable filter (46), \tilde{C} is the improved read signal, \tilde{S}⁺ is the first improved satellite signal
and wherein the second coefficient control device is arranged to minimize the correlation between the improved read signal (\tilde{C}) and the second improved satellite signal (\tilde{S}⁻) by minimizing the cost function:
J(ƒₖ⁻)=(\tilde{C}\tilde{S}⁻)²
wherein ƒₖ⁻ is the at least one adjustable coefficient of the second variable filter, and \tilde{S}⁻ is the second improved satellite signal.

7. An apparatus as claimed in claim 5, wherein the third coefficient control device (44) is arranged to minimize the correlation between the first satellite signal (S⁺) and the read signal (C) by minimizing the cost function:
J_{S}(gₖ⁺)=(C\tilde{S}⁺)²
wherein J_{S} is the cost function, gₖ⁺ is the at least one adjustable coefficient of the third variable filter (40), C is the read signal, \tilde{S}³⁰ is the first improved satellite signal
and wherein the fourth coefficient control device (45) is arranged to minimize the correlation between the second satellite signal (S⁻) and the read signal by minimizing the cost function:
J_{S}(gₖ⁻)=(C\tilde{S}−)²
wherein gₖ⁻ is the at least one adjustable coefficient of the fourth variable filter (41) and \tilde{S}− is the second improved satellite signal.

8. An apparatus as claimed in claim 1, wherein the improved read signal (\tilde{C}) is fed back to the second circuit and wherein the first circuit is arranged to suppress cross-talk of the main track present in the satellite signals (S⁺,S⁻) by minimizing a correlation between the improved satellite signals (\tilde{S}⁺,\tilde{S}⁻) and the improved read signal (\tilde{C}).

9. A method for reading information from an information carrier (11) having tracks (9), comprising the steps of
generating a main beam (31) and two satellite beams (30,32),
directing the main beam (30) to a main track and the two satellite beams (30,32) to locations adjacent to the main track,
converting a reflection of the main beam (31) from the information carrier (11) to a read signal (C) which contains information of the main track, and converting reflected satellite beams to satellite signals (S⁺,S⁻) containing information of tracks adjacent to the main track,
outputting an improved read signal (\tilde{C}) which is derived from the read signal (C) by suppressing cross-talk of the adjacent tracks present in the read signal (C),
characterized in that the method further comprises the step of outputting improved satellite signals (\tilde{S}⁺,\tilde{S}⁻) by suppressing cross-talk of the main track present in the satellite signals (S⁺,S⁻) by minimizing a correlation between the satellite signals (S⁺,S⁻) and the read signal (C), and wherein the step of outputting an improved read signal (\tilde{C}) suppresses cross-talk of the adjacent tracks present in the read signal (C) by minimizing a correlation between the improved read signal (\tilde{C}) and the improved satellite signals (S⁺,\tilde{S}⁻).

10. Method as claimed in claim 9, wherein the satellite beams (30,32) are directed to a position halfway between the main track and the adjacent tracks.

11. Method as claimed in claim 9, wherein the satellite beams (30,32) are directed towards the adjacent tracks.

12. Method as claimed in claim 9, wherein the step of outputting an improved read signal (\tilde{C}) comprises the substeps of
a) filtering a first improved satellite signal (\tilde{S}⁺) with a first variable filter (46) having at least one adjustable coefficient,
b) filtering a second improved satellite signal (\tilde{S}⁻) with a second variable filter (47) having at least one adjustable coefficient,
c) outputting the improved read signal (\tilde{C}) by subtracting the filtered improved satellite signals from the read signal (C),
d) minimizing a correlation between the first improved satellite signal (\tilde{S}⁺) and the improved read signal (\tilde{C}) by controlling the adjustable coefficient of the first variable filter (46),
e) minimizing a correlation between the second improved satellite signal (\tilde{S}⁻) and the improved read signal (\tilde{C}) by controlling the adjustable coefficient of the second variable filter (47),
f) outputting a first filtered read signal by filtering the read signal (C) with a third variable filter (40) having at least one variable coefficient,
g) outputting the first improved satellite signal (\tilde{S}⁺) by subtracting the first filtered read signal from the first satellite signal (S⁺),
h) minimizing a correlation between the first improved satellite signal (\tilde{S}⁺) and the read signal by controlling the adjustable coefficient of the third variable filter (40),
i) outputting a second filtered read signal by filtering the read signal (C) with a fourth variable filter (41) having at least one variable coefficient,
j) outputting the second improved satellite signal (\tilde{S}−) by subtracting the second filtered read signal from the second satellite signal (S⁻), and
k) minimizing a correlation between the second improved satellite signal (\tilde{S}⁻) and the read signal (C) by controlling the adjustable coefficient of the fourth variable filter (41).

13. A method as claimed in claim 11 wherein substep d minimizes the correlation by minimizing the cost function:
J(ƒₖ⁺)=(\tilde{C}\tilde{S}⁺)²
wherein J is the cost function, ƒₖ⁺ is the at least one adjustable coefficient of the first variable filter (46), \tilde{C} is the improved read signal, \tilde{S}⁺ is the first improved satellite signal
and wherein substep e minimizes the correlation by minimizing the cost function:
J(ƒₖ⁻)=(\tilde{C}\tilde{S}−)²
wherein ƒₖ⁻ is the at least one adjustable coefficient of the second variable filter (47),
and \tilde{S}⁻ is the second improved satellite signal.

14. A method as claimed in claim 11, wherein the substep h minimizes the correlation by minimizing the cost function:
J_{S}(gₖ⁺)=(C\tilde{S}+)²
whereingₖ⁺ is the at least one adjustable coefficient of the third variable filter (40), and \tilde{S}⁺ is the first improved satellite signal, and wherein substep k minimizes the correlation by minimizing the cost function:
J_{S}(gₖ⁻)=(C\tilde{S}−)²
wherein gₖ⁻ is the at least one adjustable coefficient of the fourth variable filter (41), and \tilde{S}− is the second improved satellite signal.

15. Method as claimed in claim 9, wherein the step of outputting the improved satellite signals (\tilde{S}⁺,\tilde{S}⁻) improves the satellite signals (S⁺,S⁻) by suppressing cross-talk of the main track present in the satellite signals (S⁺,S⁻) by minimizing a correlation between the improved satellite signals (\tilde{S}⁺,\tilde{S}⁻) and the improved read signal (\tilde{C}).
